(19) United States
(12) Patent Application Publication
(10) Pub. No.: US 2024/0422854 A1
(43) Pub. Date: Dec. 19, 2024

(54) USER PLANE ENTITY AND CONTROL PLANE ENTITY OF WIRELESS COMMUNICATION SYSTEM, AND OPERATION METHODS THEREOF

(71) Applicant: Samsung Electronics Co., Ltd., Suwon-si (KR)

(72) Inventors: Hyeongyo JEONG, Suwon-si (KR); Gyeongsik KIM, Suwon-si (KR); Jaesun SHIM, Suwon-si (KR); Junbeom LEE, Suwon-si (KR); Taehoon LEE, Suwon-si (KR)

(21) Appl. No.: 18/816,892

(22) Filed: Aug. 27, 2024

Related U.S. Application Data
(63) Continuation of application No. PCT/KR2023/001493, filed on Feb. 2, 2023.

(30) Foreign Application Priority Data
Feb. 28, 2022 (KR) 10-2022-0026231
Mar. 21, 2022 (KR) 10-2022-0034766

(51) Int. Cl. H04W 76/20; H04M 15/00; H04W 72/044

(52) U.S. Cl. CPC H04W 76/20; H04M 15/58; H04M 15/64; H04W 72/044

(57) ABSTRACT

A user plane entity of a wireless communication system including the user plane entity and a control plane entity according to an embodiment may comprise: a at least one processor, comprising processing circuitry, individually and/or collectively, is configured to: detect whether a session message, which has been transmitted to the control plane entity by the user plane entity, for the volume quota allocation of a resource of the user plane entity is lost; generate a session message, including an arbitrary usage report, based on the session message being detected as being lost; and a communication interface, comprising communication circuitry, is configured to transmit the session message including the usage report to the control plane entity to attempt volume quota allocation.

### CROSS-REFERENCE TO RELATED APPLICATIONS

This application is a continuation of International Application No. PCT/KR2023/001493 designating the United States, filed on Feb. 2, 2023, in the Korean Intellectual Property Receiving Office and claiming priority to Korean Patent Application Nos. 10-2022-0026231, filed on Feb. 28, 2022, and 10-2022-0034766, filed on Mar. 21, 2022, in the Korean Intellectual Property Office, the disclosures of each of which are incorporated by reference herein in their entireties.

### BACKGROUND

### Field

The disclosure relates to a user plane entity and a control plane entity of a wireless communication system, and operating methods thereof.

### Description of Related Art

In order to improve the efficiency of devices in wireless communication systems, a method of dividing the devices into control plane devices for control and user plane devices for users may be introduced. When this dividing method is introduced, an Sx/N4 interface section may be added between the control plane and the user plane for information exchange between the control plane devices and the user plane devices. The Sx/N4 interface section may transmit information related to traffic control and/or usage defined in the control plane to the user plane. In addition, the Sx/N4 interface section may transmit usage used in the user plane to a charging server through the control plane.

During the process of transmitting usage between a user plane and a control plane, a message including the usage may be lost due to various reasons such as network congestion and/or network failure. According to the 3GPP standard, in order to compensate for the loss of messages including usage, an operation of operating a timer for a predefined time T1 (the time to recognize a message transmission failure), and retransmitting the same message number of times N1 (a maximum number of retransmission in a case of Sx message transmission failure), when there is no response from the other party within the time T1 is prescribed.

However, when the network congestion or failure occurs for a period exceeding the number of times N1 and the time T1 as defined in the standard protocol, the messages including the usage (e.g., a session report request message and/or a session modification request message for volume quota allocation) may be lost. The loss of the session report request message or the session modification request message may lead to traffic service problems for the user, and thus, appropriate response is required.

### SUMMARY

In various embodiments, it is possible to restore a service abnormal state, in which a packet drop state persists when a message for a volume quota trigger (e.g., a session report request message) and/or a message for volume quota allocation (e.g., a session modification request message) are lost due to the temporary network congestion and/or network failure by a communication system by itself.

In various embodiments, it is possible to provide a continuous packet transmission service to a subscriber (the user) through repeated restoration attempts in a service abnormality state.

In various embodiments, it is possible to request for session deletion when repeated attempts to restore the packet drop state fail to allocate a volume quota.

In various embodiments, it is possible to request for deletion of resource allocated to the user plane for a session when communication is restored after repeated attempts to restore the packet drop state but the session and resource requested by the user are not present in the control plane.

According to an example embodiment, a user plane entity of a wireless communication system including the user plane entity and a control plane entity may include: at least one processor, comprising processing circuitry, individually and/or collectively, configured to: detect whether a session message for volume quota allocation for a resource of the user plane entity, transmitted by the user plane entity to the control plane entity, is lost, and generate a session message including an arbitrary usage report based on detecting that the session message is lost, and a communication interface, comprising communication circuitry, configured to transmit the session message including the usage report to the control plane entity to attempt the volume quota allocation.

According to an example embodiment, a control plane entity of a wireless communication system including a user plane entity, the control plane entity, and an online charging server (OCS) may include: at least one processor, comprising processing circuitry, individually and/or collectively, configured to: detect whether a session message, in which a user plane inactivity report (UPIR) bit requesting session deletion among report types of the session message is set, is received from the user plane entity, and determine whether a session requested by the user plane entity and a resource for the session are present according to the reception of the session message, and a communication interface, comprising communication circuitry, configured to transmit a message requesting a credit update of the user plane entity to the OCS based on the determination of whether the session and the resource for the session are present.

According to an example embodiment, a method of operating a user plane entity in a wireless communication system including the user plane entity and a control plane entity may include: detecting whether a session message for volume quota allocation for a resource of the user plane entity, transmitted by the user plane entity to the control plane entity, is lost, based on detecting that the session message is lost, generating a session message including an arbitrary usage report, and attempting the volume quota allocation by transmitting the session message including the usage report to the control plane entity.

According to an example embodiment, a method of operating a control plane entity in a wireless communication system including a user plane entity, the control plane entity, and an online charging server (OCS) may include: receiving a session message, in which a user plane inactivity report (UPIR) bit requesting session deletion among report types of the session message is set, from the user plane entity, determining whether a session requested by the user plane entity and a resource for the session are present according to the reception of the session message, and transmitting a message requesting a credit update of the user plane entity to the OCS based on the determination of whether the session and the resource for the session are present.

A communication system according to various example embodiments may restore a service abnormal state, in which a packet drop state persists due to message loss due to temporary network congestion and/or network failure by itself by performing repeated restoration attempts a preset number of times or more, without operator intervention.

A communication system according to various example embodiments may request for session deletion to prevent/reduce additional resource consumption when repeated attempts to restore the packet drop state fail to allocate a volume quota.

A communication system according to various example embodiments may improve the efficiency of resource management by requesting for deletion of resource allocated to the user plane for a session when communication is restored after repeated attempts to restore the packet drop state but the session and resource requested by the user are not present in the control plane.

In addition, various effects that are directly or indirectly identified through the present disclosure may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a signal flow diagram illustrating an example process of performing volume quota allocation when no failure occurs in a wireless communication system according to various embodiments;

FIG. 2 is a block diagram illustrating an example configuration of a user plane entity of a wireless communication system according to various embodiments;

FIG. 3 is a block diagram illustrating an example configuration of a control plane entity of a wireless communication system according to various embodiments;

FIG. 4 is a signal flow diagram illustrating an example method of repeatedly attempting volume quota allocation to restore a packet drop state in a wireless communication system according to various embodiments;

FIG. 5 is a signal flow diagram illustrating an example method of repeatedly attempting volume quota allocation to restore a packet drop state in a wireless communication system according to various embodiments;

FIG. 6 is a diagram illustrating example report types of a session message used in a wireless communication system according to various embodiments;

FIG. 7 is a signal flow diagram illustrating an example operation of each entity when communication is restored after repeated attempts to restore a packet drop state in a wireless communication system according to various embodiments;

FIG. 8 is a flowchart illustrating an example method of operating a user plane entity according to various embodiments; and

FIG. 9 is a flowchart illustrating an example method of operating a control plane entity according to various embodiments.

### DETAILED DESCRIPTION

It should be appreciated that the various example embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” may include any one of the items listed together in the corresponding one of the phrases, or all possible combinations thereof. Terms such as “1st”, “2nd”, or “first” or “second” may simply be used to distinguish the component from other components in question, and do not limit the components in other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), the component may be coupled with the other component directly (e.g., by wire), wirelessly, or via a third component.

As used in connection with various example embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to various example embodiments, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to various example embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Hereinafter, various example embodiments will be described in greater detail with reference to the accompanying drawings. When describing the various example embodiments with reference to the accompanying drawings, like reference numerals refer to like components and a repeated description related thereto may be omitted.

For convenience of description, the present disclosure uses terms and names defined in the 3rd Generation Partnership Project Long Term Evolution (3GPP LTE) standard, or terms and names modified based on the standard. However, the disclosure is not limited by the terms and names and may be applied to systems that comply with other standards in the same manner.

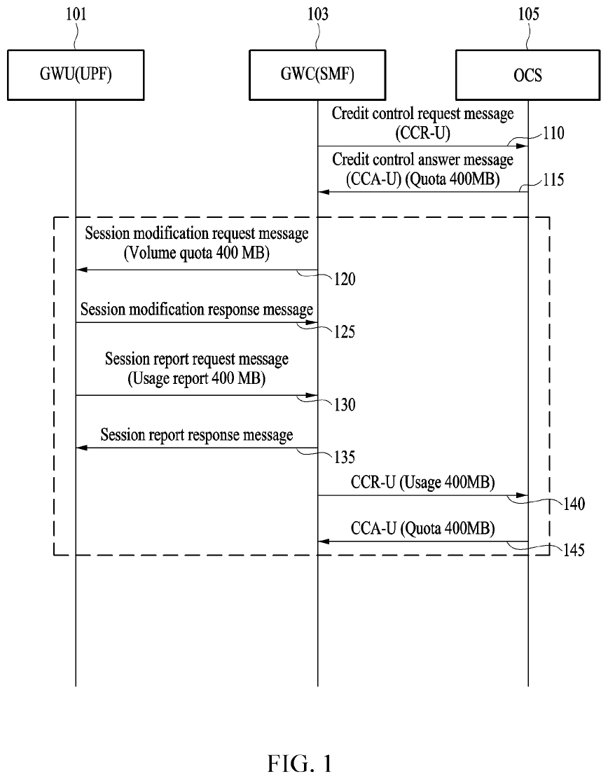

FIG. 1 is a signal flow diagram illustrating an example process of performing volume quota allocation when no failure occurs in a wireless communication system according to various embodiments.

Hereinafter, the term “session” described in the present disclosure may refer, for example, to a flow of data generated by a combination of wireless communication devices capable of exchanging data with each other. In other words, a session may be understood as a logical connection for communication between communication devices in a network environment.

An “entity” may refer to a component in a system or a program. An entity may have the same meaning as a component, an element, an object, or a subject, and when distinguished by a function, it may be used with the same meaning as a function. An entity in a communication system may refer to a component that performs a predetermined function in a network, for example, a gateway, a mobility management entity (MME), and an access management function (AMF), but is not necessarily limited thereto.

“Traffic” may refer to data transmitted and received via a network. Traffic may be transmitted and received in a form of a packet, for example, but is not necessarily limited thereto.

“GWU” may refer to a user plane gateway, and “UPF” may refer to a user plane function node. The UPF is an entity that forwards user data, and for example, may be a structure that focuses on packet processing for fast user data processing. The UPF may not store session information in the UPF or may store only a portion of the session information in a storage such as a cache for faster data processing and cost reduction. For example, when there is no session information at all in the UPF, it may be difficult to provide continuous service to a user terminal when the UPF fails.

A “user plane entity” may be understood as a component that transmits and/or processes user data, such as a packet, a flow, and/or traffic in a network. Hereinafter, the “GWU” and the “UPF” may be collectively referred to as a “user plane entity”. The “GWU (UPF)” shown in each drawing may be understood to represent a user plane entity.

In addition, “GWC” described in the present disclosure may refer to a control plane gateway, and “SMF” may refer to a session management function node. The SMF is an entity that manages a session, and may be, for example, an entity having various functions to control a network and a terminal. For example, when a user terminal includes a plurality of sessions, an SMF may be allocated for each session, and the user terminal may be connected to at least one SMF.

A “control plane entity” may correspond to a component that transfers and/or processes control data on a network. Hereinafter, the “GWC” and the “SMF” may be collectively referred to as a “control plane entity”. The “GWC (SMF)” shown in each drawing may be understood to represent a control plane entity.

Referring to FIG. 1, a GWU (UPF) 101, a GWC (SMF) 103, and an online charging system (OCS) 105 may request reallocation of a volume quota after allocating and using the volume quota through operations 110 to 145.

In operation 110, the GWC (SMF) 103 may report, for example, a volume quota allocation request of a subscriber A to the OCS 105 using a credit control request message (e.g., a CCR-U message) requesting for a credit update of a user plane entity.

In operation 115, the OCS 105 may confirm a quota corresponding to the subscriber A, and transmit a credit control response message (e.g., a CCA-U message) including the quota (e.g., 400 MB) allocated to the subscriber A to the GWC (SMF) 103. The GWC (SMF) 103 may configure a session state and hold the session state according to information included in the CCA-U message.

In operation 120, the GWC (SMF) 103 may inform a volume quota allocated to the subscriber A by transmitting a session modification request message including the quota (e.g., 400 MB) allocated to the subscriber A to the GWU (UPF) 101. The session modification request message may correspond to a message transmitted by the GWC (SMF) 103 to the GWU (UPF) 101 to inform the volume quota allocated to the GWU (UPF) 101 by the OCS 105. Here, the “volume quota” may refer to the amount of traffic that the GWU (UPF) 101 may transmit at one time, that is, the amount of a traffic transmission limit of the GWU (UPF) 101. The volume quota may be informed by the OCS 105 to the GWU (UPF) 101 through the GWC (SMF) 103. The volume quota, for example, may vary depending on a rate plan chosen by the subscriber A.

In operation 125, the GWU (UPF) 101 may transmit a session modification response message to the GWC (SMF) 103 as a response (ack) to the session modification request message. The GWU (UPF) 101 may process traffic of the subscriber A up to a volume quota value (e.g., 400 MB) allocated to the subscriber A from the OCS 105 through the GWC (SMF) 103.

In operation 130, the GWU (UPF) 101 may report usage used for the traffic processing of the subscriber A by transmitting a session report request message to the GWC (SMF) 103. At this time, the session report request message may include a usage report including the traffic usage (e.g., 400 MB) of the subscriber A. The session report request message may correspond to a volume quota trigger. A volume quota trigger may be a usage report trigger, which is primarily used for online charging. As the usage report trigger, a volume threshold, a quota holding time, and/or a quota holding period may be used in addition to the volume quota described above.

In operation 135, the GWC (SMF) 103 may transmit a session report response message to the GWU (UPF) 101 in response to the session report request message.

In operation 140, the GWC (SMF) 103 may report the usage (e.g., 400 MB) received through the session report request message to the OCS 105 using the CCR-U message.

In operation 145, the OCS 105 may confirm a remaining quota after subtracting the usage reported in operation 140 from the quota allocated to the subscriber A, and reallocate the volume quota for the subscriber A using the CCA-U message.

Operations 120 to 145 described above may be repeatedly performed until the quota allocated to the subscriber A is exhausted.

According to an embodiment, when the volume quota value is transmitted to the GWU (UPF) 101 through the linkage between the GWU (UPF) 101 and the GWC (SMF) 103, and between the GWC (SMF) 103 and the OCS 105, the GWU (UPF) 101 may perform user traffic processing and charging by repeating the operations of processing user traffic equal to the volume quota value allocated from the OCS 105, reporting the usage, and reallocating the volume quota.

In the above process, when the session modification request message transmitted in operation 120 and/or the session report request message transmitted in operation 130 for the volume quota allocation are lost, the reallocation of the volume quota for the subscriber may not be performed.

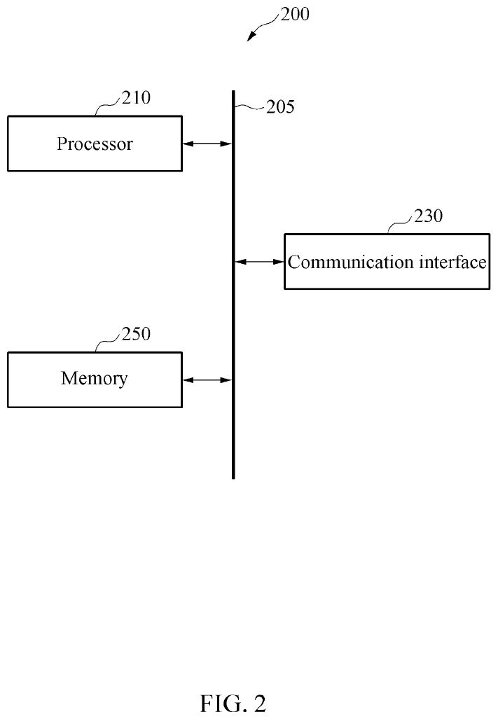

FIG. 2 is a block diagram illustrating an example configuration of a user plane entity of a wireless communication system according to various embodiments. Referring to FIG. 2, a user plane entity 200 according to an embodiment (e.g., the GWU (UPF) 101 of FIGS. 1, 4, 5, and/or 7) may include a processor (e.g., including processing circuitry) 210, a communication interface (e.g., including communication circuitry) 230, and a memory 250. The processor 210, the communication interface 230, and the memory 250 may be connected to each other via a communication bus 205.

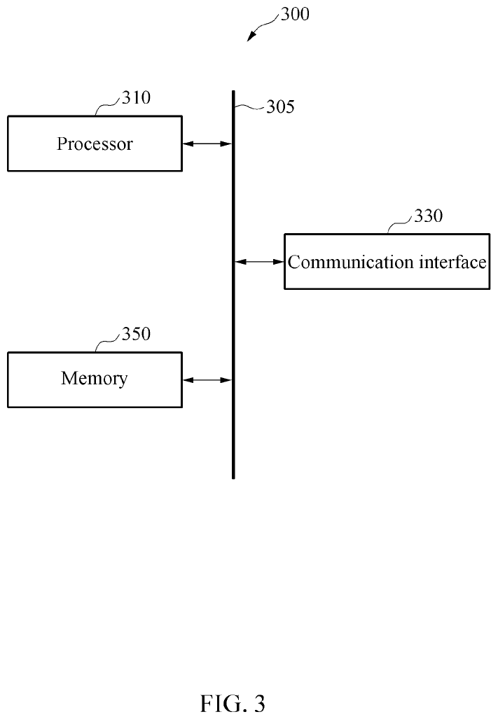

The processor 210 may include various processing circuitry and detect whether a session message for volume quota allocation for a resource of the user plane entity 200, transmitted by the user plane entity 200 to a control plane entity (e.g., the GWC (SMF) of FIGS. 1, 4, 5, and 7, and/or the control plane entity 300 of FIG. 3) is lost. The session message may include, for example, an Internet Protocol (IP) address, a domain name server (DNS) address, and quality of service (QOS) information for a network device allocated when generating a session, but is not limited thereto.

When it is detected that the session message is lost, the processor 210 may generate a session message including an arbitrary usage report. The arbitrary usage report may include, for example, at least one of a usage report with a set trigger for volume quota allocation, and a usage report in which a start trigger for informing the start of traffic transmission and volume quota allocation is set.

The processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The communication interface 230 may include various communication circuitry and transmit the session message including the usage report to a control plane entity 300 to attempt the volume quota allocation.

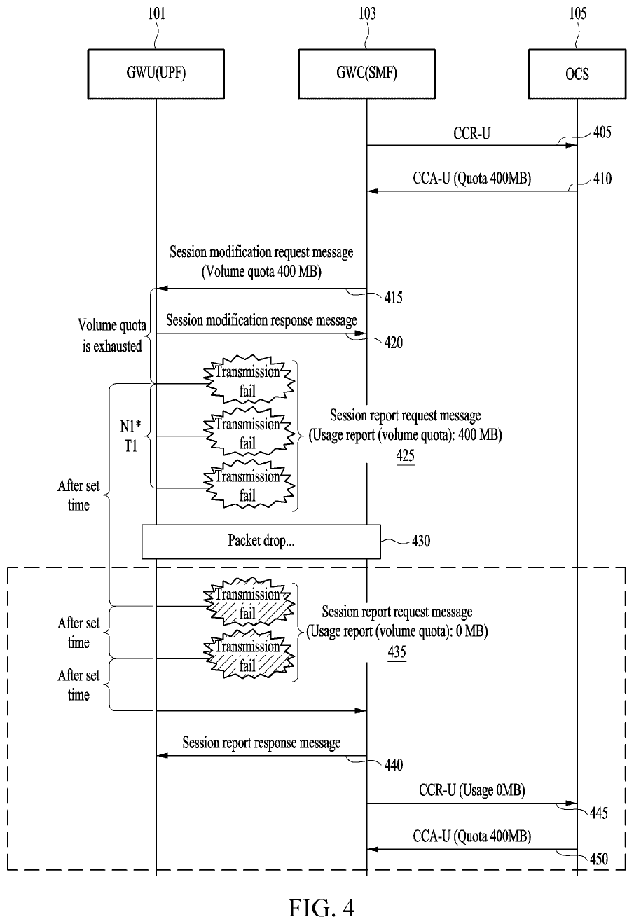

For example, due to a temporary network abnormality or a network element (NE) abnormality, session messages such as a session report request message and/or a session modification request message may be lost during transmission, resulting in a persistent packet drop state. A “packet drop” state may be understood as a state in which one or more packets fail to reach an intended destination and are discarded, resulting in packet loss. The packet drop state will be described in greater detail below with reference to FIG. 4.

When the packet drop state persists, the user plane entity 200 may attempt to resolve the packet drop state by continuously attempting the transmission, for example, by a session report request message including a usage report with a set trigger for volume quota allocation (“volume quota trigger”). The user plane entity 200 may attempt to resolve the packet drop state by continuously attempting the transmission by a session report request message including a usage report in which a start trigger (“start of traffic trigger”) for informing the start of traffic transmission and volume quota allocation is set.

The processor 210 may detect whether a session message is lost based on at least one of a maximum number of retransmission of the session message and a time at which a transmission failure of the session message is recognized. The processor 210 may generate, for example, a session message in which usage of the arbitrary usage report is set to “0”.

The processor 210 may generate a session message in which a user plane inactivity report (UPIR) bit requesting for session deletion among report types of the session message is set. At this time, the communication interface 230 may transmit the session message in which the UPIR bit is set to the control plane entity 300.

In order to attempt the volume quota allocation, the processor 210 my repeatedly retransmit the session message including the usage report to the control plane entity 300 a preset number of times.

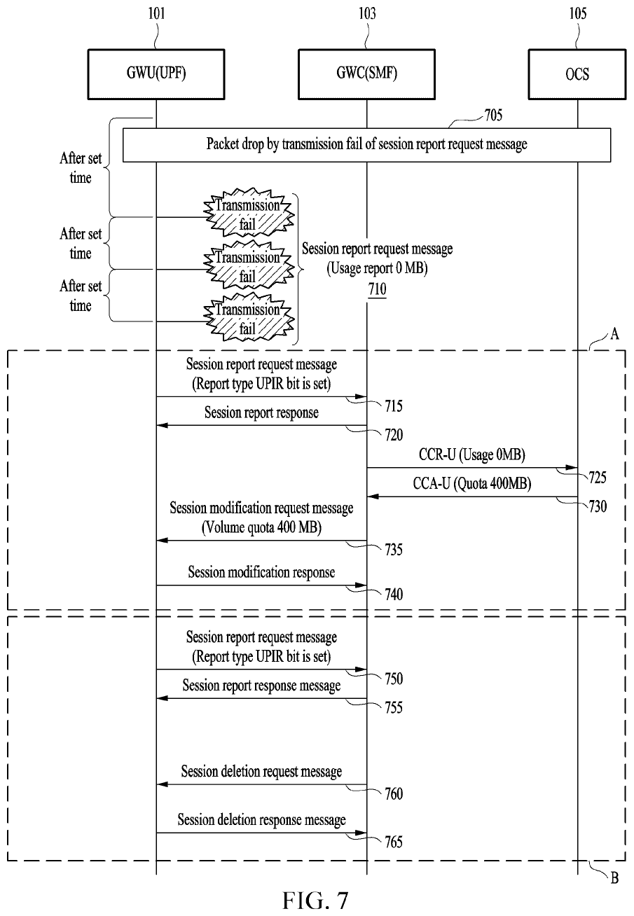

When a time set by the control plane entity 300 for the user plane entity 200 has elapsed, or the volume quota allocation is not provided while the repeated retransmission is performed the preset number of times, the processor 210 may, for example, request for session deletion by transmitting the session message, in which the UPIR bit requesting for the session deletion is set, to the control plane entity 300 (e.g., operation 715 and/or operation 750 of FIG. 7). According to determination that one of a session corresponding to the session deletion request and a resource of the control plane entity 300 is not present in the control plane entity 300, the communication interface 230 may receive a session deletion request message requesting for deletion of a resource corresponding to the session, transmitted from the control plane entity 300.

The memory 250 may store various messages transmitted and received through the communication interface 230 in addition to the session message including the arbitrary usage report generated by the processor 210.

FIG. 3 is a block diagram illustrating an example configuration of a control plane entity of a wireless communication system according to various embodiments. Referring to FIG. 3, the control plane entity 300 of a wireless communication system including a user plane entity (e.g., the GWU (UPF) 101 of FIGS. 1, 4, 5, and 7, and/or the user plane entity 200 of FIG. 2), a control plane entity (e.g., the GWC (SMF) 103 of FIGS. 1, 4, 5, and/or 7), and an OCS (e.g., the OCS 105 of FIGS. 1, 4, 5, and/or 7) according to an embodiment may include a processor (e.g., including processing circuitry) 310, a communication interface (e.g., including communication circuitry) 330, and a memory 350. The processor 310, the communication interface 330, and the memory 350 may be connected to each other via a communication bus 305.

The processor 310 may include various processing circuitry and detect whether a session message, in which a UPIR bit requesting for session deletion among report types of the session message is set, is received from the user plane entity 200. When a session message is received, the processor 310 may determine whether a session requested by the user plane entity 200 and a resource for the session are present according to the reception of the session message.

The processor 310 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The communication interface 330 may include various communication circuitry and transmit a message requesting for a credit update of the user plane entity 200 to the OCS based on the determination whether the session and the resource for the session are present.

When it is determined that the session and the resource for the session are present, the processor 310 may generate a message requesting for the credit update in which the usage is set to “0”. At this time, the communication interface 330 may transmit the message requesting for the credit update in which the usage is set to “0” to the OCS.

When it is determined that the session and the resource for the session are not present, the processor 310 may generate a message requesting for deletion of the resource corresponding to the session requested by the user plane entity 200. At this time, the communication interface 330 may transmit the message requesting for the deletion to the user plane entity 200.

FIG. 4 is a signal flow diagram illustrating an example method of repeatedly attempting volume quota allocation to restore a packet drop state in a wireless communication system according to various embodiments. FIG. 4 is a signal flow diagram illustrating a method of attempting volume quota allocation using a usage report in which a trigger for volume quota allocation is set when a packet drop occurs according to various embodiments.

According to an embodiment, the GWU (UPF) 101, the GWC (SMF) 103, and the OCS 105 may repeatedly attempt the volume quota allocation through operations 405 to 450 to restore the packet drop state.

Since operations 405 to 420 of FIG. 4 are the same as or similar to operations 110 to 125 described above with reference to FIG. 1, the following description will focus on operations that are different from those in FIG. 1.

In operation 420, in response to the session modification request message transmitted by the GWC (SMF) 103 to the GWU (UPF) 101 in operation 415, the GWU (UPF) 101 may transmit a session modification response message to the GWC (SMF) 103. At this time, the session modification request message may not be transmitted to the GWU (UPF) 101 due to network congestion or communication failure.

Although the session modification request message is normally transmitted in operation 415, the transmission failure of a session report request message may occur during the process in which the GWU (UPF) 101 transmits the session report request message to the GWC (SMF) 103 in operation 425.

When the transmission failure of the session report request message is repeated for a preset N1/T1, the volume quota allocated to the GWU (UPF) 101 may expire. Accordingly, the GWC (SMF) 103 may maintain a packet drop state, in which a packet transmitted to the GWU (UPF) 101 is dropped, as in operation 430, until the volume quota is reallocated. Here, the time “T1” may correspond to the time at which the message transmission failure is recognized. The time “T1” may be counted by a counter, for example. The number “N1” may correspond to a maximum number of retransmission in a case of message transmission failure.

According to the retransmission operation defined in the 3GPP standard, there is no way to respond appropriately when the network is abnormal or a communication partner is in an abnormal state. In particular, usage reporting rules (URRs) with volume quota triggers are bound to remain in the packet drop state when the volume quota is not reallocated. At this time, the URR is used to collect traffic usage from the GWU (UPF) 101 for use in charging. For example, a volume quota amount set in the URR may be compared with a traffic amount transmitted by the subscriber A to determine whether to perform additional transmission to the subscriber A.

However, when the GWU (UPF) 101 itself deletes the URR or session resource for which a packet is being dropped, a resource mismatch with the GWC (SMF) 103 may occur, or charging usage of a subscriber may be deleted. As a result, according to the 3GPP standard, the GWU (UPF) 101 may continue to maintain abnormal resource until another command is received from the GWC (SMF) 103, even in an abnormal packet drop state.

In an embodiment, in operation 435, when the volume quota is not allocated by the time set in the GWU (UPF) 101 due to the message transmission failure, the GWU (UPF) 101 may attempt to allocate the volume quota by transmitting the session report request message including an arbitrary user report to the GWC (SMF) 103 again for the preset N1/T1. At this time, the usage may be set to “0” in the usage report included in the session report request message transmitted in operation 435.

According to an embodiment, when the transmission state of a network is unstable or a failure temporarily occurs in a network device, the GWU (UPF) 101 may repeat attempts to reallocate the volume quota by itself as in operation 435, even after the preset N1/T1 to change the state to one where the traffic of the subscriber A may be transmitted again. At this time, the number of attempts to release the persistent packet drop state after the preset N1/T1 may be set variously depending on a network system. FIG. 4 may show a case where the number of attempts to release the packet drop state is, for example, 3.

When the network transmission state improves again or the temporary network device failure is resolved within three times of attempts, in operation 440, the GWC (SMF) 103 may transmit a session report response message to the GWU (UPF) 101 in response to the session report request message transmitted in operation 435.

In operation 445, the GWC (SMF) 103 may report the usage (e.g., 0 MB) received through the session report request message in operation 435 to the OCS 105 using a CCR-U message, thereby preventing and/or reducing any subtraction due to the traffic incurred for the subscriber A due to the message transmission failure.

In operation 450, the OCS 105 may reallocate a volume quota (e.g., 400 MB) for the subscriber A through a CCA-U message by confirming the remaining quota for the subscriber A without subtracting the usage (0 MB) reported in operation 445 from the quota allocated to the subscriber A.

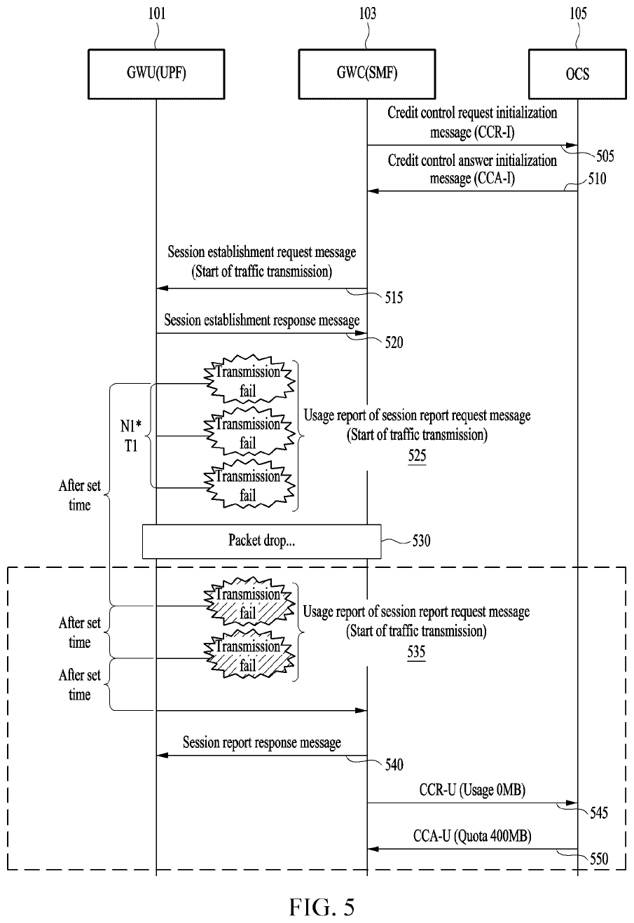

FIG. 5 is a signal flow diagram illustrating an example method of repeatedly attempting volume quota allocation to restore a packet drop state in a wireless communication system according to various embodiments. According to an embodiment, when the GWU (UPF) 101 requests for a volume quota, a start trigger (“start of traffic trigger”) for informing the start of traffic transmission and volume quota allocation may be set as the usage report trigger, instead of the volume quota trigger, to request for the volume quota when a first packet is transmitted to the URR.

Referring to FIG. 5, the GWU (UPF) 101, the GWC (SMF) 103, and the OCS 105 may perform operations 505 to 550 of attempting the volume quota allocation using the usage report in which the start trigger for informing the start of traffic transmission and the volume quota allocation is set, when a packet drop occurs.

In operation 505, the GWC (SMF) 103 may request for session establishment by transmitting a credit control request-initialization (CCR-I) message to the OCS 105.

In operation 510, the OCS 105 may request to confirm that a resource for the session requested by the GWC (SMF) 103 is successfully allocated by transmitting a credit control answer-initialization (CCA-I) to the GWC (SMF) 103.

After confirming that the resource for the session is successfully allocated, in operation 515, the GWC (SMF) 103 may transmit a session establishment request message to the GWU (UPF) 101. At this time, in a usage report included in the session establishment request message, a start trigger (“start of traffic trigger”) for informing the start of traffic transmission and volume quota allocation may be set so that a volume quota may be requested when a first packet is transmitted to the URR.

In operation 520, in response to the session establishment request message transmitted by the GWC (SMF) 103 to the GWU (UPF) 101 in operation 515, the GWU (UPF) 101 may transmit a session establishment response message to the GWC (SMF) 103. At this time, the session establishment request message may not be transmitted to the GWU (UPF) 101 due to network congestion or communication failure.

Although the session establishment request message is normally transmitted in operation 515, the transmission failure of a session report request message may occur during the process in which the GWU (UPF) 101 transmits the session report request message to the GWC (SMF) 103 in operation 525. The usage report of the session report request message transmitted in operation 525 may include start trigger (“start of traffic trigger”) for informing the start of traffic transmission and volume quota allocation.

When the transmission failure of the session report request message is repeated for the preset N1/T1, a previously allocated volume quota may expire, and the GWC (SMF) 103 may maintain the packet drop state in which a packet transmitted to the GWU (UPF) 101 is dropped as in operation 530 until a volume quota is reallocated.

In an embodiment, in operation 535, when the volume quota is not allocated by the time set in the GWU (UPF) 101 due to the message transmission failure, the GWU (UPF) 101 may attempt to allocate the volume quota by transmitting the session report request message including an arbitrary user report to the GWC (SMF) 103 again for the preset N1/T1. At this time, the usage may be set to “0” in the usage report included in the session report request message transmitted in operation 535.

According to an embodiment, when the transmission state of a network is unstable or the state of a network device is unstable, the GWU (UPF) 101 may repeat attempts to reallocate the volume quota by itself as in operation 535, even after the preset N1/T1 to change the state to one where the traffic of the subscriber A may be transmitted again. At this time, the number of attempts to release the persistent packet drop state after the preset N1/T1 may be set variously depending on a network system. FIG. 5 may correspond to an operation in which the number of attempts to release the packet drop state is, for example, 3.

When the network transmission state improves again or the temporary network device failure is resolved within three times of attempts, in operation 540, the GWC (SMF) 103 may transmit a session report response message to the GWU (UPF) 101 in response to the session report request message transmitted in operation 525.

In operation 545, the GWC (SMF) 103 may report the usage (e.g., 0 MB) received through the session report request message in operation 535 to the OCS 105 using a CCR-U message, thereby preventing and/or reducing any subtraction due to the traffic incurred for the subscriber A due to the message transmission failure.

In operation 550, the OCS 105 may reallocate a volume quota (e.g., 400 MB) for the subscriber A through a CCA-U message by confirming the remaining quota for the subscriber A without subtracting the usage (0 MB) reported in operation 545 from the quota allocated to the subscriber A.

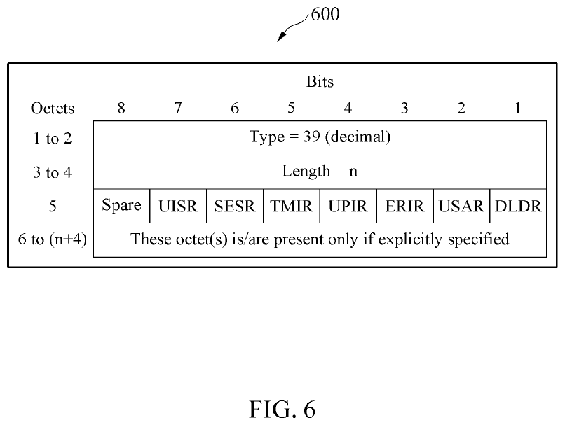

FIG. 6 is a diagram illustrating example report types of a session message used in a wireless communication system according to various embodiments. FIG. 6 illustrates a table 600 showing report types of a session message according to various embodiments.

The report types included in a session message may be encoded, for example, as in the table 600. The table 600 may show the types of reports that are transmitted by user plane entities (e.g., the GWU (UPF) 101 of FIGS. 1, 4, 5, and FIG. 7 and/or the user plane entity 200 of FIG. 2) to control plane entities (e.g., the GWC (SMF) of FIGS. 1, 4, 5, and 7 and/or the control plane entity 300 of FIG. 3).

For example, in the report types, when a bit 1 is set to “1”, it may indicate that the report is a downlink data report (DLDR), and when a bit 2 is set to “1”, it may indicate that the report is a usage report (USAR). When a bit 3 is set to “1”, it may indicate that the report is an error indication report (ERIR), and when a bit 4 is set to “1”, it may indicate that the report is an user plane inactivity report (UPIR).

When a bit 5 is set to “1”, it may indicate that the report is a TSC management information report (TMIR), and when a bit 6 is set to “1”, it may indicate that the report is a session report (SESR).

In addition, when a bit 7 is set to “1”, it may indicate that the report is a UP initiated session request (UISR).

In an embodiment, the UPIR bit corresponding to the bit 4 may be used to transmit a session deletion or a volume quota reallocation request from the GWU (UPF) to the GWC (SMF). For example, when there is no data transmission from the GWC (SMF) for a set period of time, the GWU (UPF) may request to delete the session by transmitting a session report request message, in which the UPIR bit is set, to the GWC (SMF).

FIG. 7 is a signal flow diagram illustrating an example operation of each entity when communication is restored after repeated attempts to restore a packet drop state in a wireless communication system according to various embodiments. FIG. 7 illustrates example operations (operations 715 to 765) performed between the GWU (UPF) 101, the GWC (SMF) 103, and the OCS 105 when a packet drop occurs as in operation 705 due to a transmission failure of a session report request message according to various embodiments.

When the transmission failure of the session report request message is repeated for a preset N1/T1, a volume quota allocated to the GWU (UPF) 101 may expire. In this case, the GWC (SMF) 103 may maintain a packet drop state, in which a packet transmitted to the GWU (UPF) 101 is dropped, as in operation 705, until the volume quota is reallocated.

In an embodiment, in operation 710, when the volume quota is not allocated by the time set in the GWU (UPF) 101 due to the transmission failure of the session message, the GWU (UPF) 101 may attempt to allocate the volume quota by transmitting a session report request message including an arbitrary user report to the GWC (SMF) 103 a preset number of times. At this time, the usage may be set to “0” in a usage report included in the session report request message transmitted to the GWC (SMF) 103 in operation 710.

According to an embodiment, when the transmission state of a network is unstable or a failure temporarily occurs in a network device, the GWU (UPF) 101 may repeat attempts to reallocate the volume quota by itself as in operation 710, even after the preset N1/T1 to change the state to one where the traffic of the subscriber A may be transmitted again. At this time, the number of attempts (e.g., three times) to release the persistent packet drop state after the preset N1/T1 may be set variously depending on a network system.

When the volume quota is still not allocated while the attempts are performed as much as possible to restore the persistent packet drop state the number of times (e.g., three times) set in the network system as in operation 710, the GWU (UPF) 101 may finally request the GWC (SMF) 103 to delete the session. The reason why GWU (UPF) 101 requests for the session deletion may be to request for resource deletion from the GWC (SMF) 103 because unnecessary resources may continue to remain in the GWU (UPF) 101.

In order to request for the session deletion, in operation 715, the GWU (UPF) 101 may generate a session message, in which a UPIR bit requesting for session deletion among report types of the session message (e.g., the session report request message) is set, and transmit the session message to the GWC (SMF) 103 to request for the resource deletion for the GWU (UPF) 101.

At this time, the GWC (SMF) 103 may perform the following two operations depending on whether the communication is restored.

For example, when the message requesting for the resource deletion is received from the GWU (UPF) 101 as in operation 715, the network congestion may be resolved, or the communication may be restored due to the resolution of the network device failure.

For example, when the GWC (SMF) 103 is in a state of being able to receive the session message, in which the UPIR bit is set, transmitted by the GWU (UPF) 101 in operation 715, the network and/or the network device may be in a normal state. As described above, when the network and/or the network device are normalized and all session resources are remaining, the GWC (SMF) 103 may receive a new volume quota allocated from the OCS 105 and transmit it to the GWU (UPF) 101, thereby resolving the persistent packet drop state.

The operations included in a block A of FIG. 7 (operations 715 to 740) may show the operations of the network system when the network and/or the network device are normalized and all session resources are remaining.

In operation 720, GWC (SMF) 103 may send a Session Report Response message to GWU (UPF) 101 in response to the Session Report Request message sent In operation 710.

In operation 725, the GWC (SMF) 103 may report the usage (e.g., 0 MB) received through the session report request message in operation 710 to the OCS 105 using a CCR-U message, thereby preventing and/or reducing any subtraction due to the traffic incurred for the subscriber A due to the message transmission failure.

In operation 730, the OCS 105 may reallocate a volume quota (e.g., 400 MB) for the subscriber A through a CCA-U message by confirming the remaining quota for the subscriber A without subtracting the usage (0 MB) reported in operation 710 from the quota allocated to the subscriber A.

In operation 735, the GWC (SMF) 103 may transmit a session modification request message to the GWU (UPF) 101. At this time, the session modification request message may include the volume quota (e.g., 400 MB) allocated from the OCS 105.

In operation 740, in response to the session modification request message, the GWU (UPF) 101 may transmit a session modification response message to the GWC (SMF) 103.

As described above, the volume quota allocation for the resource requested by the GWU (UPF) 101 may be performed through operations 715 to 740 described above.

Although the network congestion is resolved or the network device failure is resolved, some resources may be deleted during the process of normalizing the network or the network device, or the session and the URR resource requested by the GWU (UPF) 101 to the GWC (SMF) 103 may not be present. In this case, the GWC (SMF) 103 may request for deletion of the resource requested by the GWU (UPF) 101 through operations 750 to 765 corresponding to a block B of FIG. 7.

For example, when the GWU (UPF) 101 transmits the session report request message, in which the UPIR bit is set, to the GWC (SMF) 103 in operation 750, the GWC (SMF) 103 may receive the session report request message, however, some resources may be deleted during the process of normalizing the network or the network device, or the session and the URR resource requested by the GWU (UPF) 101 may not be present in the GWC (SMF) 103.

In this case, in operation 755, in response to the session report request message, the GWC (SMF) 103 may transmit a session report response message to the GWU (UPF) 101.

In operation 760, the GWC (SMF) 103 may delete the resource requested by the GWU (UPF) 101 by transmitting a session deletion request message requesting for the deletion of the resource corresponding to the session to the GWU (UPF) 101.

The GWU (UPF) 101 that receives the session deletion request message may delete the corresponding session and then, in operation 765, transmit a session deletion response message to the GWC (SMF) 103.

For example, the network or the network device failure may not be resolved until a session report request message, in which the UPIR bit is set, corresponding to a final attempt is transmitted, and accordingly, the GWC (SMF) 103 may not be able to process the message. In this case, the GWU (UPF) 101 may stop the attempts to restore the URR in the persistent packet drop state and maintain the current state (e.g., the packet drop state). When the communication is not restored within a maximum restoration attempt time, the GWU (UPF) 101 may consider that the entire system is abnormal and maintain the current state to await operator intervention.

According to an embodiment, it is possible to attempt to restore a service abnormal state, in which the packet drop state persists when session messages (e.g., the session report request message and/or the session modification request message) are lost due to the temporary network abnormality and/or network device abnormality, by a network system by itself through repeated restoration attempts before receiving an inquiry about the service abnormality from a subscriber, without operator intervention.

According to an embodiment, when the repeated attempts to restore the packet drop state fail to allocate a volume quota, a communication system may request for the session deletion to prevent and/or reduce additional resource consumption.

According to an embodiment, when the communication is restored after the repeated attempts to restore the packet drop state, but a resource mismatch occurs between the GWC (SMF) 103 and the GWU (UPF) 101, the resource allocated to the user plane entity for the session may be induced to be deleted, thereby improving the efficiency of resource management.

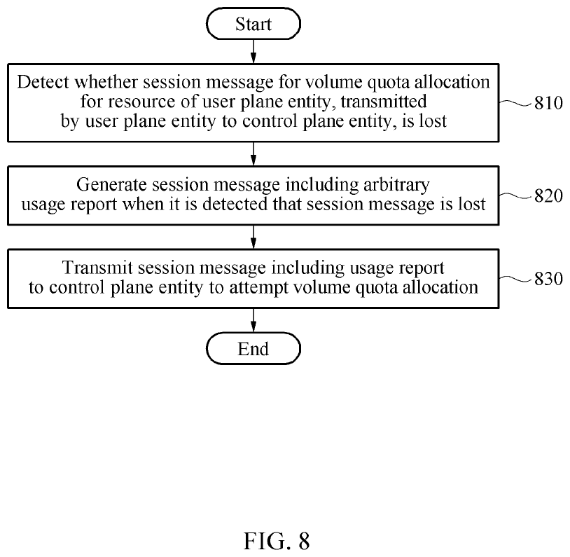

FIG. 8 is a flowchart illustrating an example method of operating a user plane entity according to various embodiments. In the example below, operations may be performed sequentially, but are not necessarily performed sequentially. For example, the order of the operations may change, and at least two operations may be performed in parallel.

Referring to FIG. 8, in a wireless communication system including a user plane entity and a control plane entity according to an embodiment, the user plane entity may attempt to allocate a volume quota through operations 810 to 830.

In operation 810, the user plane entity may detect whether a session message for volume quota allocation for a resource of the user plane entity, transmitted by the user plane entity to the control plane entity, is lost. The user plane entity may detect whether the session message is lost based on at least one of a maximum number (e.g., N times) of retransmission of the session message and a time (e.g., a timer T time) when a transmission failure of the session message is recognized.

For example, it is assumed that the maximum number of retransmission is three times and the transmission of the session message fails. The user plane entity may retransmit the session message once and wait for the time T to confirm whether the session message is transmitted. Then, when the session message is not transmitted, the user plane entity may retransmit the session message again and wait for the time T to confirm whether the session message is transmitted. Even then, when the session message is not transmitted, the user plane entity may retransmit the session message a third time and wait for the time T to confirm whether the session message is transmitted. At this time, whether the session message is transmitted or lost may be determined, for example, based on whether a response message to the session message is received from a communication partner.

In operation 820, when it is detected that the session message is lost in operation 810, the user plane entity may generate a session message including an arbitrary usage report. The user plane entity may generate a session message in which usage of the arbitrary usage report is set to “0”.

In operation 830, the user plane entity may attempt to allocate a volume quota by transmitting the session message including the usage report generated in operation 820 to the control plane entity.

The user plane entity may, for example, generate the session message in which a UPIR bit requesting for session deletion among report types of the session message is set, and transmit the session message in which the UPIR bit is set to the control plane entity. The user plane entity may attempt to allocate a volume quota by repeatedly retransmitting the session message including the usage report to the control plane entity a preset number of times. When a time set by the control plane entity for the user plane entity has elapsed, or the volume quota allocation is not provided while the repeated retransmission is performed the preset number of times, the user plane entity may request for session deletion to the control plane entity by transmitting the session message, in which the UPIR bit requesting for the session deletion is set.

According to determination that one of a session corresponding to the session deletion request and a resource of the control plane entity is not present, the user plane entity may receive a session deletion request message requesting for deletion of a resource corresponding to the session, from the control plane entity.

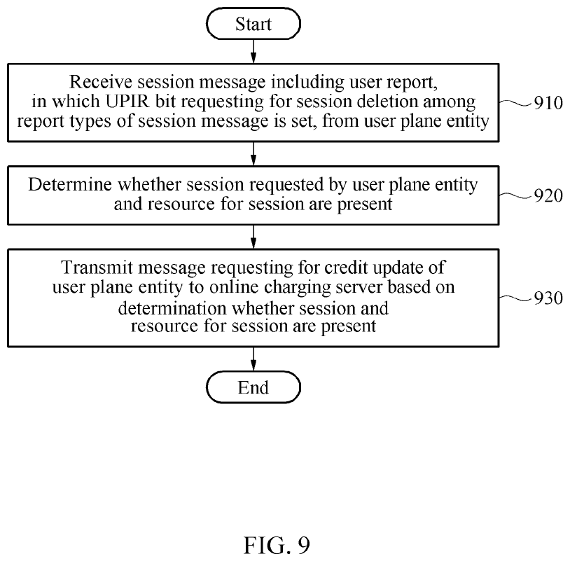

FIG. 9 is a flowchart illustrating an example method of operating a control plane entity according to various embodiments. In the example below, operations may be performed sequentially, but are not necessarily performed sequentially. For example, the order of the operations may change, and at least two operations may be performed in parallel.

Referring to FIG. 9, in a wireless communication system including a user plane entity, a control plane entity, and an OCS according to an embodiment, the control plane entity may attempt to allocate a volume quota through operations 910 to 930.

In operation 910, the control plane entity may receive a session message, in which a UPIR bit requesting for session deletion among report types of the session message is set, from the user plane entity.

In operation 920, the control plane entity may determine whether a session requested by the user plane entity and a resource for the session are present according to the reception of the session message in operation 910.

In operation 930, the control plane entity may transmit a message (e.g., a CCR-U message) requesting a credit update of the user plane entity to the OCS based on the determination whether the session and the resource for the session are present in operation 920. For example, when it is determined that the session and the resource for the session are present, the control plane entity may transmit a message requesting for the credit update in which usage is set to “0” to the OCS.

When it is determined that the session and the resource for the session are not present, the control plane entity may transmit, to the user plane entity, a message (e.g., a session deletion request message) requesting for deletion of the resource corresponding to the session requested by the user plane entity.

According to an example embodiment, a user plane entity (e.g., 101, 200) of a wireless communication system including the user plane entity (e.g., 101, 200) and a control plane entity (e.g., 103, 300) may include: at least one processor (e.g., 210), comprising processing circuitry, individually and/or collectively configured to: detect whether a session message for volume quota allocation for a resource of the user plane entity (e.g., 101, 200), transmitted by the user plane entity (e.g., 101, 200) to the control plane entity (e.g., 103, 300), is lost, and generate a session message including an arbitrary usage report based on detecting that the session message is lost, and a communication interface (e.g., 230), including communication circuitry, configured to transmit the session message including the usage report to the control plane entity (e.g., 103, 300) in order to attempt the volume quota allocation.

According to an example embodiment, at least one processor, individually and/or collectively, may be configured to detect whether the session message is lost based on at least one of a maximum number of retransmission of the session message and a time at which a transmission failure of the session message is recognized.

According to an example embodiment, at least one processor, individually and/or collectively, may be configured to generate a session message in which usage of the arbitrary usage report is set to “0”.

According to an example embodiment, the arbitrary usage report may include at least one of a usage report in which a trigger for the volume quota allocation is set, and a usage report in which a start trigger for informing the start of traffic transmission and volume quota allocation is set.

According to an example embodiment, at least one processor, individually and/or collectively, may be configured to generate the session message in which a UPIR bit requesting for session deletion among report types of the session message is set, and the communication interface may be configured to transmit the session message in which the UPIR bit is set to the control plane entity.

According to an example embodiment, at least one processor, individually and/or collectively, may be configured, in order to attempt the volume quota allocation, to repeatedly retransmit the session message including the usage report to the control plane entity a specified number of times.

According to an example embodiment, based on a time set by the control plane entity for the user plane entity elapsing, or the volume quota allocation not being provided while the repeated retransmission is performed the specified number of times, at least one processor, individually and/or collectively, may be configured to request session deletion by transmitting the session message, in which the UPIR bit requesting for the session deletion is set, to the control plane entity.

According to an example embodiment, the communication interface may be configured to, based on a determination that one of a session corresponding to the session deletion request and a resource of the control plane entity not being present in the control plane entity, receive a session deletion request message requesting deletion of a resource corresponding to the session, transmitted from the control plane entity.

According to an example embodiment, a control plane entity (e.g., 103, 300) of a wireless communication system including a user plane entity (e.g., 101, 200), the control plane entity (e.g., 103, 300), and an OCS (e.g., 105) may include at least one processor (e.g., 310), comprising processing circuitry, individually and/or collectively, configured to: detect whether a session message, in which a UPIR bit requesting for session deletion among report types of the session message is set, is received from the user plane entity (e.g., 101, 200), and determine whether a session requested by the user plane entity (e.g., 101, 200) and a resource for the session are present according to the reception of the session message, and a communication interface (e.g., 330), comprising communication circuitry, configured to transmit a message requesting for a credit update of the user plane entity (e.g., 101, 200) to the OCS (e.g., 105) based on the determination whether the session and the resource for the session are present.

According to an example embodiment, at least one processor, individually and/or collectively, may be configured to, based on determining that the session and the resource for the session are present, generate a message requesting for the credit update in which usage is set to “0”, and the communication interface may be configured to transmit the message requesting for the credit update in which the usage is set to “0” to the OCS.

According to an example embodiment, at least one processor, individually and/or collectively, may be configured to, based on determining that the session and the resource for the session are not present, generate a message requesting for deletion of the resource corresponding to the session requested by the user plane entity, and the communication interface may be configured to transmit the message requesting for the deletion to the user plane entity.

According to an example embodiment, a method of operating a user plane entity (e.g., 101, 200) in a wireless communication system including the user plane entity (e.g., 101, 200) and a control plane entity (e.g., 103, 300) may include: detecting whether a session message for volume quota allocation for a resource of the user plane entity (e.g., 101, 200), transmitted by the user plane entity (e.g., 101, 200) to the control plane entity (e.g., 103, 300), is lost, based on detecting that the session message is lost, generating a session message including an arbitrary usage report, and attempting the volume quota allocation by transmitting the session message including the usage report to the control plane entity (e.g., 103, 300).

According to an example embodiment, the detecting of whether the session message is lost may include detecting whether the session message is lost based on at least one of a maximum number of retransmission of the session message and a time at which a transmission failure of the session message is recognized.

According to an example embodiment, the generating of the session message may include generating the session message in which usage of the arbitrary usage report is set to “0”.

According to an example embodiment, the attempting of the volume quota allocation may include generating the session message in which a UPIR bit requesting for session deletion among report types of the session message is set, and transmitting the session message in which the UPIR bit is set to the control plane entity.

According to an example embodiment, the attempting of the volume quota allocation may include attempting the volume quota allocation by repeatedly retransmitting the session message including the usage report to the control plane entity a specified number of times, and based on a time set by the control plane entity for the user plane entity elapsing, or the volume quota allocation not being provided while the repeated retransmission is performed the specified number of times, requesting for session deletion to the control plane entity by transmitting the session message, in which the UPIR bit requesting for the session deletion is set.

According to an example embodiment, the method of operating the user plane entity may further include, based on a determination that one of a session corresponding to the session deletion request and a resource of the control plane entity is not present, receiving a session deletion request message requesting deletion of a resource corresponding to the session from the control plane entity.

According to an example embodiment, a method of operating a control plane entity (e.g., 103, 300) in a wireless communication system including a user plane entity (e.g., 101, 200), the control plane entity (e.g., 103, 300), and an OCS (e.g., 105) may include receiving a session message, in which a UPIR bit requesting for session deletion among report types of the session message is set, from the user plane entity (e.g., 101, 200), determining whether a session requested by the user plane entity (e.g., 101, 200) and a resource for the session are present according to the reception of the session message, and transmitting a message requesting for a credit update of the user plane entity (e.g., 101, 200) to the OCS (e.g., 105) based on the determination whether the session and the resource for the session are present.

According to an example embodiment, transmitting the message requesting for the credit update may include, based on determining that the session and the resource for the session are present, transmitting a message requesting for the credit update in which usage is set to “0” to the OCS, and based on determining that the session and the resource for the session are not present, transmitting a message requesting deletion of the resource corresponding to the session requested by the user plane entity to the user plane entity.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A user plane entity of a wireless communication system comprising the user plane entity and a control plane entity, the user plane entity comprising:
at least one processor, comprising processing circuitry, individually and/or collectively, configured to: detect whether a session message for volume quota allocation for a resource of the user plane entity, transmitted by the user plane entity to the control plane entity, is lost, and generate a session message comprising an arbitrary usage report based on detecting that the session message is lost; and
a communication interface, comprising communication circuitry, configured to transmit the session message comprising the usage report to the control plane entity to attempt the volume quota allocation.

2. The user plane entity of claim 1, wherein at least one processor, individually and/or collectively, is configured to detect whether the session message is lost based on at least one of a maximum number of retransmission of the session message and a time at which a transmission failure of the session message is recognized.

3. The user plane entity of claim 1, wherein at least one processor, individually and/or collectively, is configured to generate a session message in which usage of the arbitrary usage report is set to 0.

4. The user plane entity of claim 1, wherein the arbitrary usage report comprises at least one of:
a usage report in which a trigger for the volume quota allocation is set; and
a usage report in which a start trigger for informing the start of traffic transmission and volume quota allocation is set.

5. The user plane entity of claim 1, wherein
at least one processor, individually and/or collectively, is configured to generate the session message in which a user plane inactivity report (UPIR) bit requesting session deletion among report types of the session message is set, and
the communication interface is configured to transmit the session message in which the UPIR bit is set to the control plane entity.

6. The user plane entity of claim 1, wherein at least one processor, individually and/or collectively, is configured to attempt the volume quota allocation, to repeatedly retransmit the session message comprising the usage report to the control plane entity a specified number of times.

7. The user plane entity of claim 6, wherein
based on a time set by the control plane entity for the user plane entity elapsing, or the volume quota allocation not being provided while the repeated retransmission is performed the specified number of times, at least one processor, individually and/or collectively, is configured to request session deletion by transmitting the session message, in which the UPIR bit requesting the session deletion is set, to the control plane entity, and
the communication interface is configured to, based on determining that one of a session corresponding to the session deletion request and a resource of the control plane entity is not present in the control plane entity, receive a session deletion request message requesting deletion of a resource corresponding to the session, transmitted from the control plane entity.

8. A control plane entity of a wireless communication system comprising a user plane entity, the control plane entity, and an online charging server (OCS), the control plane entity comprising:
at least one processor, comprising processing circuitry, individually and/or collectively, configured to: detect whether a session message, in which a user plane inactivity report (UPIR) bit requesting session deletion among report types of the session message is set, is received from the user plane entity, and determine whether a session requested by the user plane entity and a resource for the session are present according to the reception of the session message; and
a communication interface, comprising communication circuitry, configured to transmit a message requesting a credit update of the user plane entity to the online charging server based on the determination whether the session and the resource for the session are present.

9. The control plane entity of claim 8, wherein
at least one processor, individually and/or collectively, is configured to, based on determining that the session and the resource for the session are present, generate a message requesting the credit update in which usage is set to 0, and
the communication interface is configured to transmit the message requesting the credit update in which the usage is set to 0 to the online charging server.

10. The control plane entity of claim 8, wherein
at least one processor, individually and/or collectively, is configured to, based on determining that the session and the resource for the session are not present, generate a message requesting deletion of the resource corresponding to the session requested by the user plane entity, and
the communication interface is configured to transmit the message requesting the deletion to the user plane entity.

11. A method of operating a user plane entity in a wireless communication system comprising the user plane entity and a control plane entity, the method comprising:
detecting whether a session message for volume quota allocation for a resource of the user plane entity, transmitted by the user plane entity to the control plane entity, is lost;
based on detecting that the session message is lost, generating a session message in which usage of an arbitrary usage report is set to 0; and
attempting the volume quota allocation by transmitting the session message comprising the usage report to the control plane entity.

12. The method of claim 11, wherein the detecting of whether the session message is lost comprises detecting whether the session message is lost based on at least one of a maximum number of retransmission of the session message and a time at which a transmission failure of the session message is recognized.

13. The method of claim 11, wherein the attempting of the volume quota allocation comprises:
generating the session message in which a user plane inactivity report (UPIR) bit requesting session deletion among report types of the session message is set; and
transmitting the session message in which the UPIR bit is set to the control plane entity.

14. The method of claim 11, wherein the attempting of the volume quota allocation comprises:
attempting the volume quota allocation by repeatedly retransmitting the session message comprising the usage report to the control plane entity a specified number of times;
based on a time set by the control plane entity for the user plane entity elapsing, or the volume quota allocation not being provided while the repeated retransmission is performed the specified number of times, requesting session deletion to the control plane entity by transmitting the session message, in which the UPIR bit requesting the session deletion is set; and
based on determining that one of a session corresponding to the session deletion request and a resource of the control plane entity is not present, receiving a session deletion request message requesting deletion of a resource corresponding to the session from the control plane entity.

15. A method of operating a control plane entity in a wireless communication system comprising a user plane entity, the control plane entity, and an online charging server (OCS), the method comprising:
receiving a session message, in which a user plane inactivity report (UPIR) bit requesting session deletion among report types of the session message is set, from the user plane entity;
determining whether a session requested by the user plane entity and a resource for the session are present based on reception of the session message; and
transmitting a message requesting a credit update of the user plane entity to the online charging server based on determining whether the session and the resource for the session are present,
wherein the transmitting of the message requesting the credit update comprises:
based on determining that the session and the resource for the session are present, transmitting a message requesting the credit update in which usage is set to 0 to the online charging server; and
based on determining that the session and the resource for the session are not present, transmitting a message requesting deletion of the resource corresponding to the session requested by the user plane entity to the user plane entity.
